(19) United States
(12) Patent Application Publication
(10) Pub. No.: US 2015/0038184 A1
(43) Pub. Date: Feb. 5, 2015

(54) WIRELESS COMMUNICATION METHOD AND APPARATUS

(71) Applicants: Andrew Donald Macafee, Hampshire (GB); Steve Byrom, Hampshire (GB); Konrad Gooding, Hampshire (GB); David Mann, Hampshire (GB)

(72) Inventors: Andrew Donald Macafee, Hampshire (GB); Steve Byrom, Hampshire (GB); Konrad Gooding, Hampshire (GB); David Mann, Hampshire (GB)

(73) Assignee: Thales Holdings UK plc, Surrey (GB)

(21) Appl. No.: 14/114,450

(22) PCT Filed: Apr. 27, 2012
(86) PCT No.: PCT/GB2012/050943

§ 371 Date: Sep. 29, 2014

(30) Foreign Application Priority Data
Apr. 28, 2011 (GB) 1107272.5

(51) Int. Cl. H04W 76/02; H04B 7/26

(52) U.S. Cl. CPC H04W 76/02; H04B 7/26
USPC 455/509

(57) ABSTRACT

A TETRA communications system, comprising a first TETRA communication device, connected to a first communication means by means of a first data link to transport TETRA message data and control information between said first communication means and said first TETRA communication device, a second TETRA communication device connected to a second communication means by means of a second data link to transport TETRA message data and control information between said second communication means and said second TETRA communication device, wherein said first communication means and said second communication means are further operable to establish a communications link with each other over a communications network to allow said message data and control information to be transported between said first and second TETRA communication device via said first communication means and said second communication means.

### FIELD OF THE INVENTION

The present invention relates to wireless communication. It is particularly, but not exclusively, concerned with a method and apparatus for extending a communication range between two or more communication devices in a communication network.

### BACKGROUND OF THE INVENTION

TETRA (Terrestrial Trunked RAdio) is an ETSI defined standard technology, reference EN 300 392-1, for private mobile communications. The TETRA standard provides both a trunked mode (TMO) for network based connections, and a direct mode (DMO) for peer to peer connections which may be used outside the network coverage area. For instance, a terminal being used by a user in a rescue operation could be unable to establish a link with a fixed base station in TMO, but could be able to establish a peer to peer (DMO) link with another TETRA enabled device at a nearby but safer location.

The DMO mode includes functionality (EN 300 396-5) for terminals to act as gateways between DMO and TMO operational areas, thereby extending TMO operation to areas with poor network coverage.

TETRA supports a range of security features, including authentication to the network, Air Interface (AI) encryption and End to End (EE) encryption of user traffic, each of which may be used in direct mode and in trunked mode. The AI encryption encrypts signalling traffic and user traffic between the mobile station (MS) and the TETRA Switching and Management Infrastructure (SwMI), and protects against eavesdropping and traffic analysis. However, the AI encryption does not apply within the SwMI. Static or dynamic AI key encryption may be used. The mobile station must securely store all relevant Air Interface Encryption (AIE) keys, and the key lifetime may be managed by OTAR (Over the Air Re-keying). For increased confidentiality of user data, End to End encryption (E2EE) may be used. E2EE is decodable only by end users with the correct algorithm and traffic key. End to End keys are controlled by the end user organisation, and are fully independent of the network provider. They may be managed using OTAK (Over the Air Key management).

UK patent application No. 0921677.1 describes a Dual TETRA Station Interface (DTSI) that provides an alternative to the standard ETSI DMO Gateway without the need for special radio protocols or dedicated radio equipment. A software package for the Thales vector radio is used to implement the DTSI as part of the main Vector software, such that all the Vector radios are capable of DTSI operation.

A DTSI apparatus provides similar facilities to a DMO Gateway, ref EN 300 396-5, with the following main differences:
The DTSI uses two radios, whereas a Gateway is a single radio.
Operation on the DMO talkgroup is un-affected by the use of a DTSI. With a standard Gateway in a DMO talkgroup, DMO operation is affected as all DMO calls must connect to the Gateway and are not allowed to proceed until a TMO link has been established. This gives additional delays in both directions.
The DMO net timing is slaved to TMO timing by the Gateway. A DTSI uses independent timing on both nets.
A DMO station which moves out of range of the Gateway cannot communicate with local DMO radios. With a DTSI, if a TMO link cannot be established immediately, all or part of the call will be lost into the TMO network, but the DMO call can proceed.
A Gateway guarantees connections between the DMO and TMO nets whereas a DTSI provides a best-effort service.

The DTSI protocol broadly comprises a set of proprietary messages transferred between two TETRA radios over an RS232 link. The RS232 link is capable of supporting a separation of 15 m and simple conversion to RS422 or RS485 can increase the range to 1200 m.

By way of background, FIG. 1 illustrates a Dual TETRA Station Interface (DTSI) according to the prior art. A dual Vector radio configuration is used to allow communication between TETRA DMO and TMO nets. The DTSI includes a first radio 100 and a second radio 200 connected together by a link cable 300. The two radios 100, 200 have their own Individual TETRA subscriber Identity (ITSI). Each radio 100, 200 comprises standard TETRA mobile station hardware. In this example, the first TETRA radio 100 is used for TMO communications and the second TETRA radio 200 is used for DMO communications. However, in some cases, each radio may be used in either TMO mode or in DMO mode.

The first radio 100 and the second radio 200 each has an antenna 105, 205, a data interface connector 101, 201, a user control interface connector 102, 202, and a data device connector 103, 203. A DTSI link cable 300 is connected between the data interface connector 101 of the first radio 100 and the data interface connector 201 of the second radio 200. This DTSI link cable is preferably a serial data link, and allows data such as voice traffic, user data, SDS (Short Data Service) messages, OTAK (Over The Air Key management) messages and control information to be transferred in either direction between the first radio 100 and the second radio 200. The Intra-DTSI serial link cable connects the RS232 data lines to allow message transfer and also will allow the radio with the user interface to turn on and off the other radio. In an alternative configuration, instead of a link cable being provided, a data link may be established by wireless means, e.g. Bluetooth.

A control unit (CLU) or remote control unit (RCU) is connected to the first 100 or second 200 radio to allow local control and operation of the DTSI. The CLU or RCU allows the operator full speed access to the primary operational DMO net. In this example, a control unit (CLU) 310 is connected via a cable 320 to the controller interface connector 202 of the DMO radio 200, which will be the master of the pair of radios. In alternative configuration, the DTSI radio pair can also be controlled via a remote control unit (RCU) e.g. a wireless controller, or remotely from a dispatcher on the TMO, e.g. using SDS messages. In another configuration, the DTSI radio pair may be controlled by an MMI integral to one of the radios. The use of only a single user controller can prevent control conflict and audio phasing issues. The control unit can also be connected to the TMO radio 100 instead of the DMO radio 200.

The DTSI radio pair 100, 200 can be controlled via the control unit 310. The control unit 310 includes a keypad 312, a display 311 and a PTT (Push To Talk) control 313. The control unit 310 allows powering on and off the DTSI radio pair, e.g. by turning on or off both radios whenever the DMO radio 200 is turned on or off. The control unit 310 controls the operation of both the first and the second radios, by sending appropriate control signals through the link cable 300 to the first radio 100. The control unit 310 allows the talkgroup for each radio to be changed together (keeping both radios in step). It also allows a user to monitor both the TMO network and the DMO network simultaneously, and to transmit on both the TMO network and the DMO network simultaneously. The keypad 312 allows a user to change the mode, the channel, or any other relevant parameters on both of the first 100 and second 200 radios simultaneously, or on one of these radios individually. The display 311 can be configured to display information on channel, mode, etc, other user information or control information relating to one or both of the first and second radios, or to display text or data transmissions. The PTT control 313 allows a user to transmit on both the TMO network via the first radio 100, and the DMO network via the second radio 200. Transmission can be to either network or to both networks together. Optionally, the first or second radio can be connected via the TETRA Peripheral Equipment Interface (PEI) to a data device, e.g. via a cable or a wireless link. In this example, the second radio 200 has a cable 204 connected to its data device connector 203, to provide a PEI connection. This allows the DTSI system to be connected to a data terminal such as a computer 321.

The DTSI is designed for either or both of the following two modes of operation:
(i) Unattended, typically at a fixed site. In this scenario a remote control function is used, and there is typically no local End to End (EE) key material. Preferably, the control unit would be replaced by a Remote Control unit (RCU) when the DTSI is used in this mode, to prevent unwanted audio output.
(ii) Attended, typically in a vehicle. In this case the operator will be able to participate in the DMO net. Typically, the primary radio will be fitted with a TSM (TETRA Security Module) loaded with the correct EE keys, so that all traffic on the DMO net can be monitored via the CLU audio. Typically, the secondary radio will not be loaded with EE keys. A local PTT can be used to transmit on the DMO net, and request a TMO transmission. Any local clash between incoming TMO traffic and a local PTT will be dealt with by the TMO protocol. If the correct EE key for decryption of a received transmission is not present, the DTSI will still transmit the call through the DTSI, but will not allow local monitoring.

There is a desire to extend the communication range between two Thales vector radios; one radio operating in the DMO gateway mode and the other operating in the TMO mode with both radios running the DTSI software to provide DMO-TMO TETRA connectivity. Further extension of the DTSI interface communications range, beyond that supported by a serial connection, requires consideration of alternative bearers between the two radios, e.g., modems, mobile phones, Ethernet, Wi-Fi, WiMAX or the Internet.

### SUMMARY OF THE INVENTION

A first aspect of the invention provides a TETRA communications system, comprising a first TETRA communication device, operable to establish a first communications link in an ETSI standard TETRA direct mode or trunked mode with a respective other device or devices, a first communication means connected to said first TETRA communication device by means of a first data link to transport TETRA message data and control information between said first communication means and said first TETRA communication device, a second TETRA communication device, operable to establish a second communications link in an ETSI standard TETRA direct mode or trunked mode with a respective other device or devices, a second communication means connected to said second TETRA communication device by means of a second data link to transport TETRA message data and control information between said second communication means and said second TETRA communication device, wherein said first communication means and said second communication means are further operable to establish a communications link with each other over a communications network to allow said message data and control information to be transported between said first TETRA communication device and said second TETRA communication device via said first communication means and said second communication means, and further comprising a control means connected to said first TETRA communications device or said second TETRA communication device to control operation of said first and second TETRA communications devices.

One of the TETRA radios may be configured to operate in direct mode (DMO), and the other in trunked mode (TMO), to provide gateway services from direct mode to trunked mode. However, this is not essential, and a further embodiment of the invention comprises DMO to DMO operation i.e. configuring both radios for DMO and repeating DMO calls on one DMO net into another DMO net. In embodiments of the invention, the following modes may be supported: DMO-DMO, DMO-TMO, TMO-TMO.

Alternative embodiments of the invention could use non-TETRA bearers to transport TETRA user data for one of the communications links.

Each of said first and second communication means may be operable to transmit an acknowledgment signal to its respective first and second TETRA communication devices within a predetermined time interval, upon reception of a message data from said respective first and second TETRA communication devices.

The first communication means may be operable to transmit an acknowledgement signal to said second communication means upon reception of a message data from said second communication means.

The second communication means may be operable to transmit an acknowledgement signal to said first communication means upon reception of a message data from said first communication means.

Each of said first and second communication means may include a data storage means for storing an interim response to said message data.

Each of said first and second communication means may be operable to transmit said interim response to its respective first and second TETRA communication devices upon reception of said message data.

The first communication means may be operable to update said data storage means with a response, upon reception of said response from said second communication means.

The second communication means may be operable to update said data storage means with a response, upon reception of said response from said first communication means.

Each of said first and second communication means may be operable to monitor traffic on its respective first and second data link.

Each of said first and second communication means may be operable to compress said message data.

Each of said first and second communications means may be operable to configure said data storage means to operate as a data buffer for storing a received message data.

Each of said first and second communication means may be operable to control the rate at which said received message data is transmitted to its respective first and second TETRA communication devices upon reception of said message data.

Each of said first and second data link may comprise a local low delay wired or wireless link.

Each of said first and second data link may be a serial data cable.

The communications network may comprise a packet network or a switched network, for example an IP or ISDN respectively.

A second aspect of the invention provides a TETRA communications apparatus, comprising a TETRA communication device, operable to establish a communications link in an ETSI standard TETRA direct mode or trunked mode with a respective other device or devices, a communication means connected to said TETRA communication device by means of a data link to transport TETRA message data and control information between said communication means and said TETRA communication device, wherein said communication means is operable to establish a communications link with another communication means over a communications network to allow said message data and control information to be transported to another communication means connected to said communications network, further comprising a control means connected to said TETRA communications device to control operation of said TETRA communications device.

The communication means may be operable to transmit an acknowledgment signal to said TETRA communication device within a predetermined time interval, upon reception of a message data from said TETRA communication device.

The first communication means may include a data storage means for storing an interim response to said message data.

The communication means may be operable to transmit said interim response to said TETRA communication device upon reception of said message data.

The communication means may be operable to update said data storage means with a response upon reception of said response from said another communication means.

The communication means may be operable to monitor traffic on said data link.

The communication means may be operable to compress said message data.

The communications means may be operable to configure said data storage means to operate as a data buffer for storing a received message data.

The communication means may be operable to control the rate at which said received message data is transmitted to said TETRA communication device.

The data link may comprise a local low delay wired or wireless link.

The data link may be a serial data cable.

The communications network may comprise an IP network, or a mobile communications network.

A third aspect of the invention provides a method of controlling a TETRA communications system, the method comprising using a first TETRA communication device to establish a first communications link in an ETSI standard TETRA direct mode or trunked mode with a respective other device or devices, using a first data link to transport TETRA message data and control information between a first communication means and said first TETRA communication device, using a second TETRA communication device to establish a second communications link in an ETSI standard TETRA direct mode or trunked mode with a respective other device or devices, using a second data link to transport TETRA message data and control information between a second communication means and said second TETRA communication device, and operating said first communication means and said second communication means to establish a communications link with each other over a communications network to allow said message data and control information to be transported between said first TETRA communication device and said second TETRA communication device via said first communication means and said second communication means.

A fourth aspect of the invention provides a method at a TETRA communications apparatus, the method comprising using a TETRA communication device to establish a communications link in an ETSI standard TETRA direct mode or trunked mode with a respective other device or devices, using a data link to connect a communication means to said TETRA communication device to transport TETRA message data and control information between said communication means and said TETRA communication device, establishing a communications link between said communication means and another communication means over a communications network to allow said message data and control information to be transported to another communication means connected to said communications network, and controlling operation of said TETRA communications device.

Aspects of the invention may comprise a computer program product comprising computer executable instructions operable to cause a computer to become configured to perform a method in accordance with any of the above identified aspects of the invention. The computer program product can be in the form of an optical disc or other computer readable storage medium, a mass storage device such as a flash memory, or a read only memory device such as ROM. The method may be embodied in an application specific device such as an ASIC, or in a suitably configured device such as a DSP or an FPGA. A computer program product could, alternatively, be in the form of a signal, such as a wireless signal or a physical network signal.

### DESCRIPTION OF THE DRAWINGS

FIG. 1 illustrates a Dual TETRA Station Interface (DTSI) system according to the prior art;

FIG. 2 is a schematic diagram of two TETRA networks linked by two mobile phones over a mobile phone network according to an embodiment of the invention;

FIG. 3 is a schematic diagram of two TETRA networks linked by two computer terminals over a public network according to an embodiment of the invention;

FIG. 4 illustrates an exchange of messages between two TETRA radios according to an embodiment of the invention;

FIG. 5 illustrates an exchange of messages between two TETRA radios according to another embodiment of the invention;

FIG. 6 illustrates an exchange of messages between a TETRA radio and a computer terminal according to another embodiment of the invention;

FIG. 7 illustrates an exchange of messages between a TETRA radio and a computer terminal according to another embodiment of the invention;

FIG. 8 illustrates an exchange of messages between a TETRA radio and a computer terminal according to another embodiment of the invention;

FIG. 9 illustrates an exchange of messages between a TETRA radio and a computer terminal according to another embodiment of the invention;

FIG. 10 illustrates an exchange of messages between a TETRA radio and a computer terminal according to another embodiment of the invention;

FIG. 11 illustrates an exchange of messages between a TETRA radio and computer terminal according to another embodiment of the invention; and

FIG. 12 is a block diagram showing the internal structure of an apparatus according to an embodiment of the invention.

### DETAILED DESCRIPTION

Specific embodiments of the present invention will be described in further detail on the basis of the attached diagrams. It will be appreciated that this is by way of example only, and should not be viewed as presenting any limitation on the scope of protection sought.

Message protocols that are implemented with the DTSI protocol according to an embodiment of the invention will now be described. There are two distinct message protocols, namely:
The standard “AT” modem protocol for establishing a link; and
The DTSI protocol for transferring information between the TETRA radios.

Essentially, the TETRA radios establish a communication link with each other using the AT protocol. The DTSI protocol is subsequently used for the remaining of the communication between the TETRA radios once the communication link has been established.

It is noted that the timing at which AT messages are received at the TETRA radio is important. In particular, the messages must not be transmitted at a rate faster than the rate at which they can be processed.

The DTSI messages are exchanged in the following manner:
1. The sender sends a “Command” message to the receiver;
2. Upon reception of the “Command” message, the receiver sends an acknowledgment “ACK” message back to the sender;
3. The receiver then sends a “Response” to the sender;
4. The sender sends an ACK message to acknowledge receipt of the “Response” message.

The following rules are applied in the DTSI protocol.
1. All Commands and Responses require an ACK;
2. All ACKs are identical;
3. Not all Commands require a response;
4. ACKs must be received by the sender within a predetermined time interval, e.g. 30 ms, of the sender sending the message;
5. If a response is required, the sender must receive a response within a predetermined time interval, e.g. 1 second, of the Command being sent;
6. Overlapping of Commands and Responses is permissible (i.e. a TETRA radio can issue a Command while it is preparing a Response and the entire Command can be sent before the Response is sent).

Once a communication link has been established, it will be maintained by the exchange of “Health” messages between the two TETRA radios 100, 200. The Health messages may be exchanged typically at a predetermined time interval of 20 seconds. If a Health message or an ACK is absent, the DTSI link will be broken and the communication link will need to be restored. Furthermore, it is noted that a Health response must be received within a time interval of 1 second of a Health request being sent.

When the PTT (push to talk) button of a TETRA radio is activated, information about the PTT and the encryption state may be sent in a DTSI message. Encrypted digitised voice data is subsequently sent as a stream of DTSI messages. In the example described herein, each message represents 30 ms of voice data. When the PTT is deactivated this is indicated by another DTSI message.

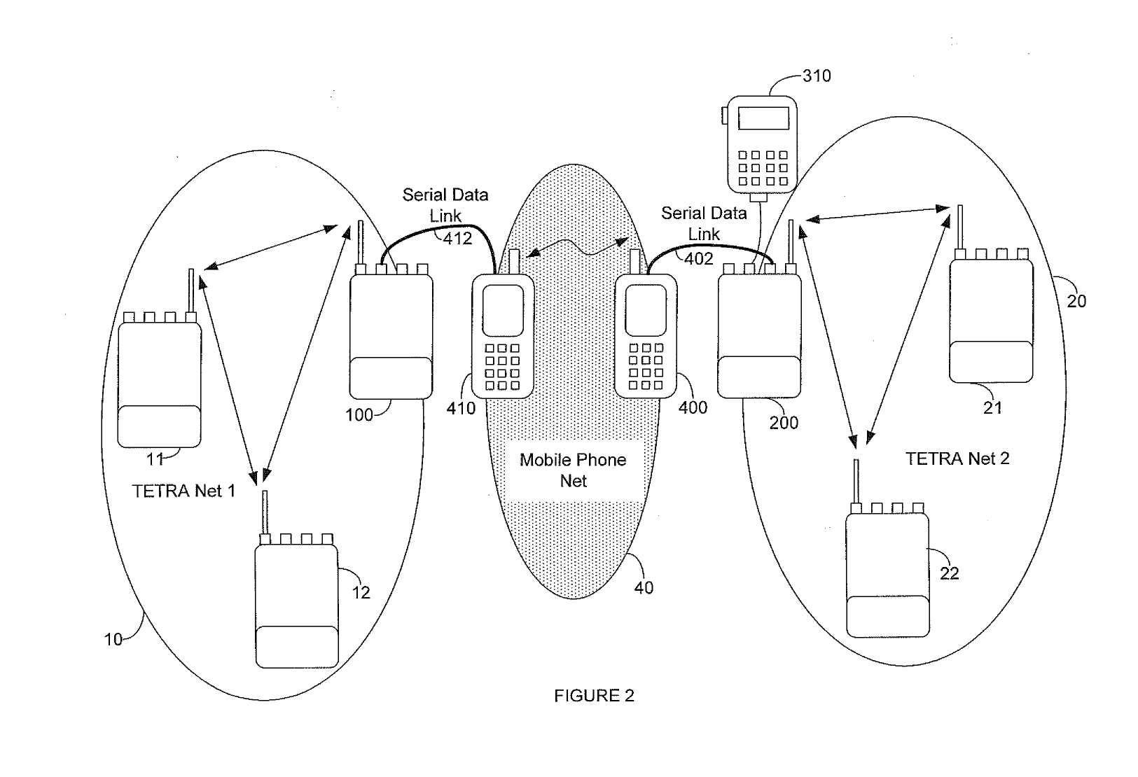

FIG. 2 illustrates a DTSI system operating within two separate TETRA networks, e.g. a DMO net and a TMO net, according to an embodiment of the invention. The control unit (CLU) is connected via a cable to the controller interface connector of the second radio 200 to control the operation of the DTSI.

The first radio 100 has established communication links with two other radios 11, 12 within a first TETRA network, labelled TETRA Net 1. The two other radios 11, 12 in this first TETRA network have also established a communication link between themselves. The second radio 200 has established communication links with two other radios 21, 22 within a second TETRA network 20, labelled TETRA Net 2. The two other radios 21, 22 have also established a communication link between themselves.

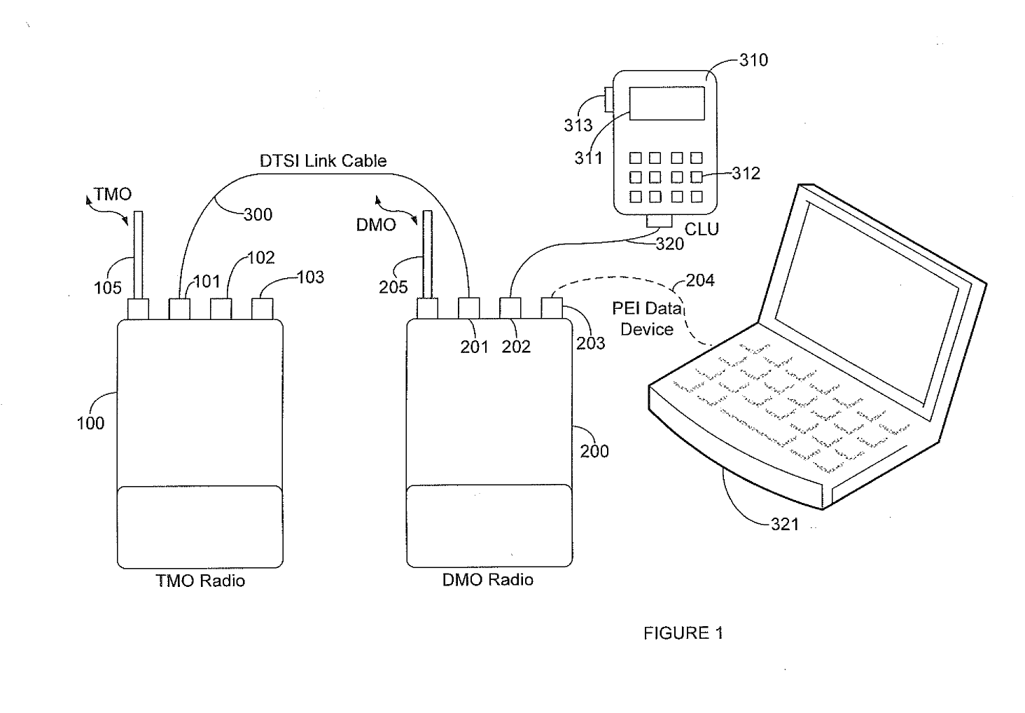

To correspond to the embodiment of FIG. 1, the TETRA Net 1 would be a TMO network, and the TETRA Net 2 would be a DMO network. However, in alternative embodiments, each TETRA Net may be either DMO or TMO or a non-TETRA bearer of TETRA user traffic. Thus, embodiments of the invention can include a DTSI for connecting two TMO networks, two DMO networks, or a TMO network and a DMO network.

Each of the TETRA radios may be connected to a talk group and is configured to extend the range of the radios in that talk group. Accordingly, the TETRA radios may contain air interface encryption keys for the radios in the talk group. The TETRA radios, however, may not require end-to-end encryption keys, that enable voice and text messages, to be decrypted.

As shown in FIG. 2, the first TETRA radio 100 is connected to a first mobile phone 410 via a serial data link cable 412, and the second TETRA radio 200 is connected to a second mobile phone 400 via another data link cable 402. In such a configuration, the communication range of the DTSI system can be extended via a mobile phone network 40, labelled Mobile Phone Net.

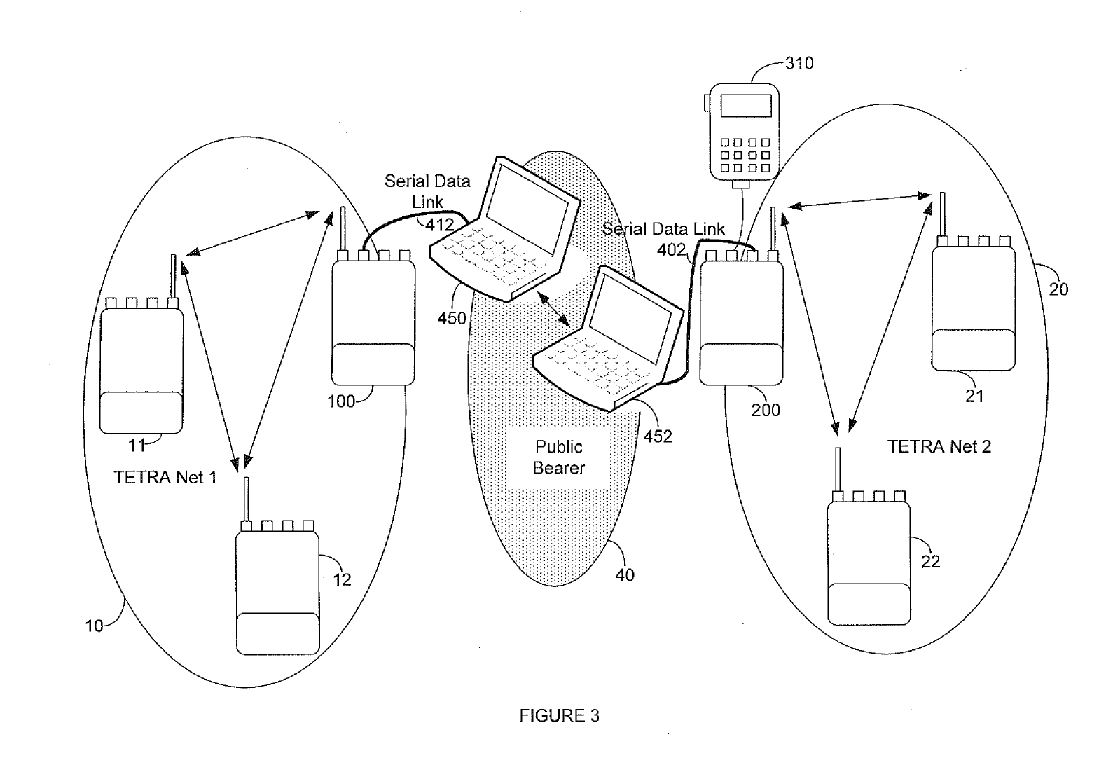

However, it is noted that the mobile phone network, or indeed any “public” bearer such as the Internet, is constrained by low bandwidth and high latency. Conversely, the serial data cable provides a high bandwidth and low latency communication link. Thus an embodiment of the invention provides intervening devices, such as computer terminals or mobile phones, to the DTSI system to facilitate data transfer over a public network. Such a configuration is illustrated in FIG. 3.

As shown in FIG. 3, the first TETRA radio 100 is now connected to a first computer terminal 450, and the second TETRA radio 200 is connected to a second computer terminal 452. It is noted that the communication link between the two TETRA radios 100, 200 can be maintained if the latency remains low enough to allow replies to all messages to be received within a predetermined time interval, e.g. 1 second. It is further noted that the latency may increase with time if the bandwidth between the two computing devices is insufficient to transfer data at a rate in which data is being generated by either of the TETRA radios 100, 200. Basically, the computer terminals 450, 452 examine the flow of DTSI messages between the TETRA radios 100, 200 and generate responses and ACK to a sender in a timely manner.

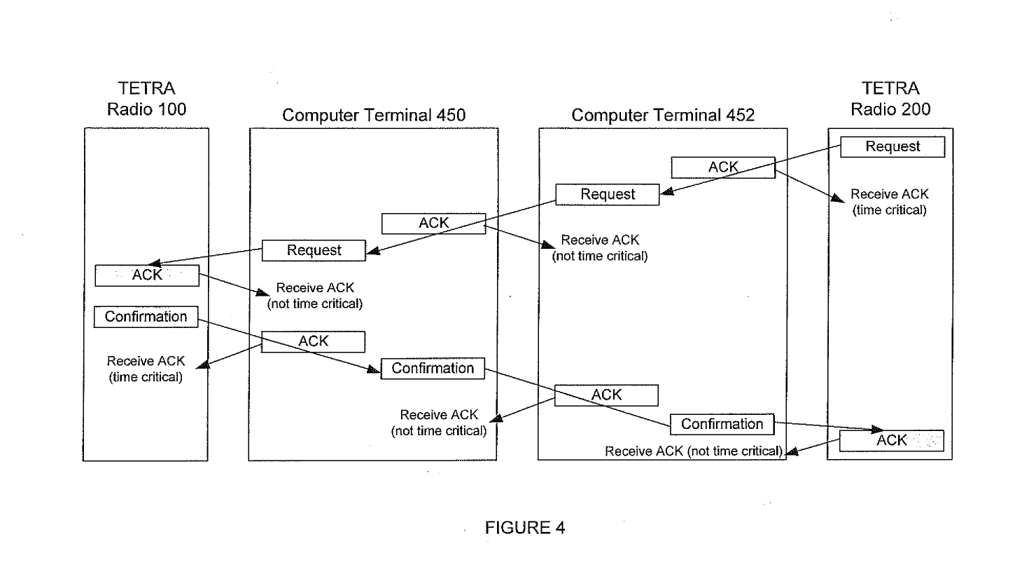

FIG. 4 illustrates an exchange of a Health request and a Health confirmation response between the first TETRA radio 100 and the second TETRA radio 200.

As shown in FIG. 4, the second TETRA radio 200 sends a Health request message to the first TETRA radio 100 through the public network 40 via the computer terminals 450, 452. Upon reception of the Health request message, the second computer terminal 452 immediately responds with a pre-installed ACK message. As discussed in the foregoing paragraphs, an ACK message must be received by the sender (in this example, TETRA radio 200) within a predetermined time interval, e.g. 30 ms, of the sender sending the Health request message in order to maintain the communication link between the two TETRA radios 100, 200. The second computer terminal 452 in turn sends the Health request message to the first computer terminal 450 which subsequently replies with an ACK message. Due to the channel characteristic of the public network, it is noted that the ACK message may require more than 30 ms to arrive at the second computer terminal 452. However, as the sender (TETRA radio 200) has already received the ACK message, the timing in which the second computer terminal 452 now receives the ACK message from the first computer terminal 450 is no longer critical. Similarly, the first computer terminal 450 sends the Health request message to the first TETRA terminal 100 which in turns replies with an ACK message.

The first TETRA terminal 100, upon sending the ACK message, responds with a “Health confirmation” message to the first computer terminal 450. Upon reception of the Health confirmation message, the first computer terminal 450 immediately responds with an ACK message. As discussed in the foregoing paragraphs, an ACK message must be received by the sender (TETRA radio 100) within 30 ms of the sender sending the Health confirmation message in order to maintain the communication link between the two TETRA terminals 100, 200. The first computer terminal 450 in turn sends the Health confirmation message to the second computer terminal 452 which subsequently replies with an ACK message. As the sender (TETRA radio 100) has already received the ACK message, the timing in which the first computer terminal 450 now receives the ACK message from the second computer terminal 452 is no longer critical. Similarly, the second computer terminal 452 sends the Health confirmation message to the second TETRA terminal 200 which in turns replies with an ACK message.

Thus, the computer terminals 450, 452, ensure that the ACK messages are received by the sender within a required time interval. However, as described in the foregoing paragraphs, it is also essential that the Health confirmation message is received within a predetermined time interval, e.g. 1 second, after the Health request message is sent by the sender.

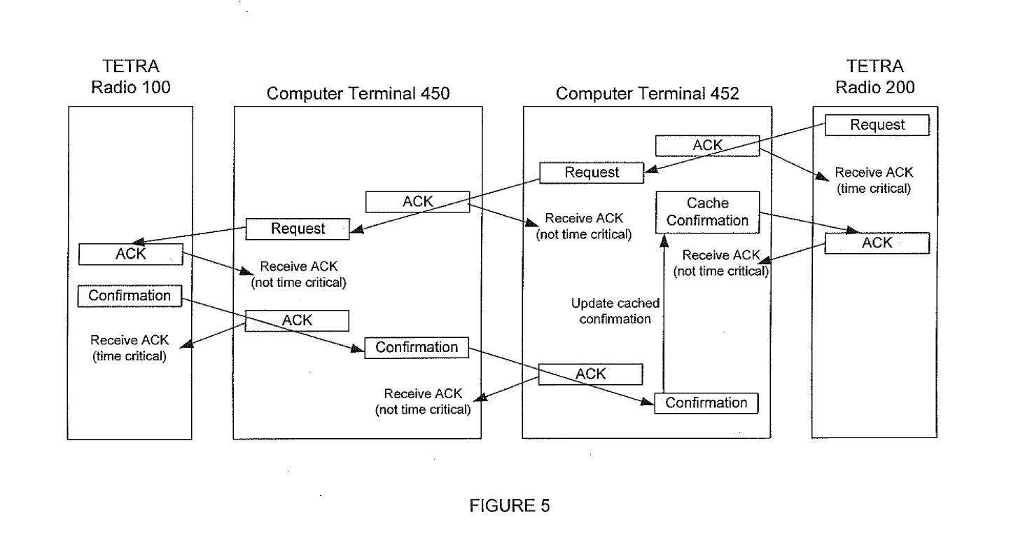

FIG. 5 illustrates an exchange of a Health request and a Health confirmation response between the first TETRA radio 100 and the second TETRA radio 200. As shown in FIG. 5, the second computer terminal 452 caches a pre-installed interim Health confirmation, such that when the second computer terminal 452 sends a ACK message to the second TETRA radio (sender), the interim Health confirmation message can be sent to the second TETRA terminal immediately to ensure that the Health confirmation message arrives at the sender within 1 second after the Health request message is being sent by the second TETRA radio 200. The cache is updated when the actual Health confirmation message from the first TETRA terminal 100 is received by the second computer terminal 452. Effectively, the subsequent Health confirmation message received by the second TETRA radio 200 is a previous Health confirmation message sent by the first TETRA radio 100 in response to a previous Health request message. The actual Health confirmation message is also compared with the interim Health confirmation message that has recently being sent to the second TETRA radio 200. If there is a difference between the two messages, a corrective message is sent to the sender (second TETRA radio 200).

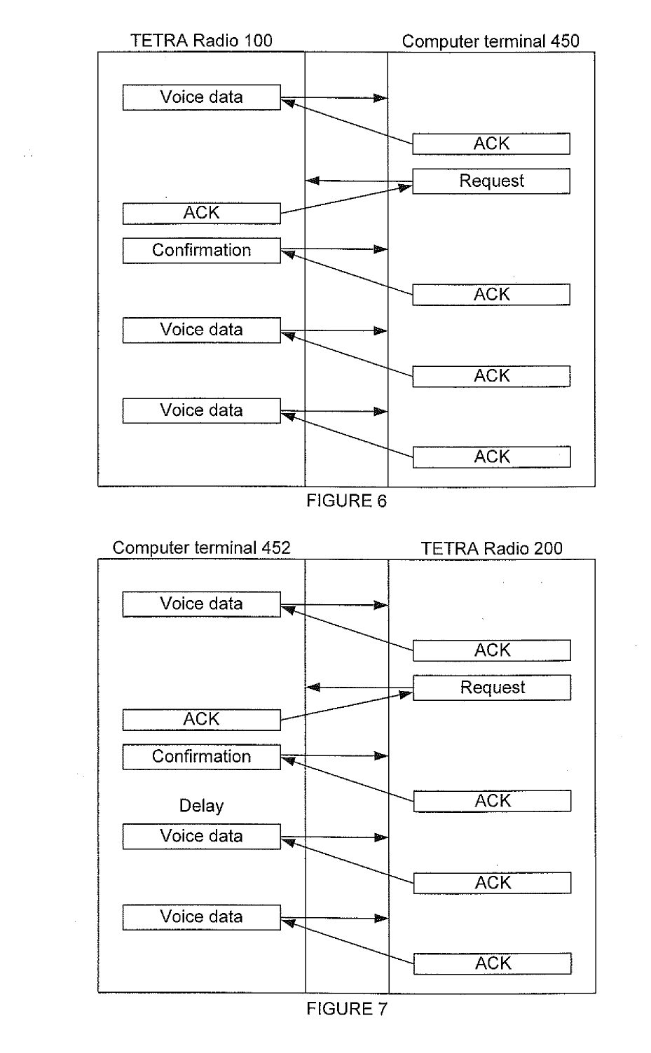

FIGS. 6 to 12 illustrate examples of exchange of messages between the first TETRA radio 100 and the second TETRA radio 200. For the sake of simplicity, the communication link between a TETRA radio and its associated computer terminal is shown.

FIG. 6 illustrates a situation in which a Health request message is received by the first TETRA radio 100 during exchange of voice data between the first TETRA radio 100 and the second TETRA radio 200. As shown in FIG. 6, the first TETRA radio 100 sends a voice data and receives an ACK message from the first computer terminal 450. The first computer terminal 450 receives a Health request message and passes it on to the first TETRA terminal 100 which replies with an ACK message. The first TETRA terminal 100 continues to send voice data to the second TETRA terminal 200.

FIG. 7 illustrates a situation in which a Health request message is sent by the second TETRA radio 200 during exchange of voice data between the first TETRA radio 100 and the second TETRA radio 200. As shown in FIG. 7, a delay (for example, 15 ms) is introduced to allow the second TETRA radio 200 to process the confirmation message before the second computer terminal 452 continues to send voice data to the second TETRA radio 200.

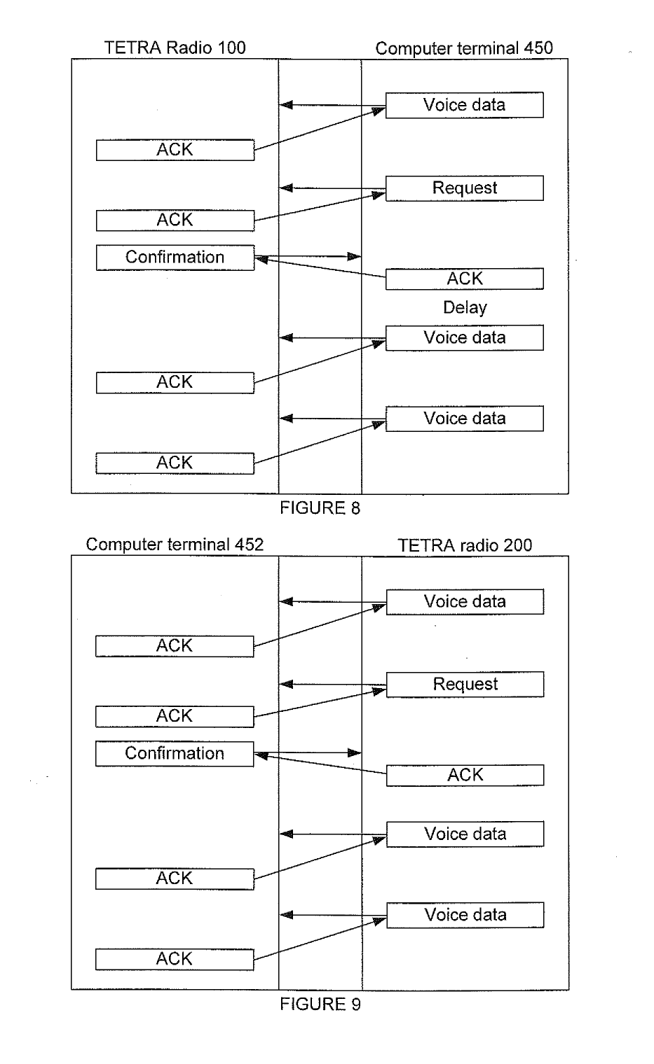

FIG. 8 illustrates a situation in which the first TETRA radio 100 receives a voice data from the second TETRA radio 200, and a Health request message is received by the first TETRA radio 100 during the exchange of voice data. As shown in FIG. 8 a delay (for example, 15 ms) is introduced to allow the first TETRA radio 100 to process the confirmation message before the first computer terminal 450 continues to send voice data to the first TETRA radio 100.

FIG. 9 illustrates a situation in which the first TETRA radio 100 receives a voice data from the second TETRA radio 200, and a Health request message is received by the first TETRA radio 100 during the exchange of voice data.

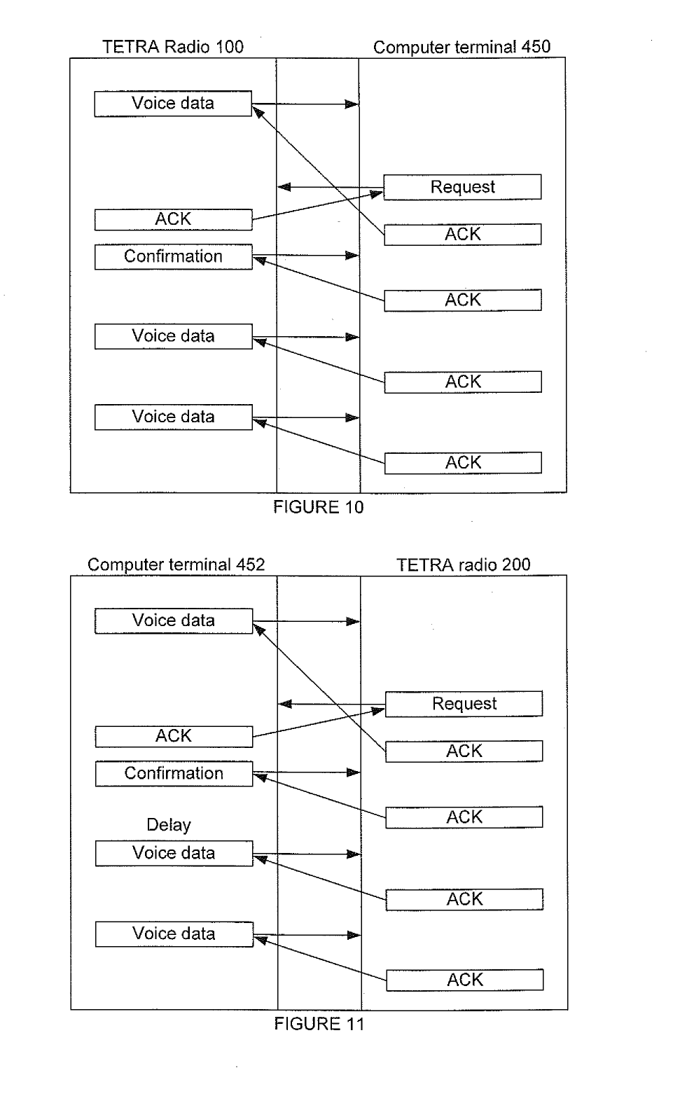

FIG. 10 illustrates a situation in which the first TETRA radio 100 receives a voice data from the second TETRA radio 200, and a Health request message is received by the first TETRA radio 100 during the exchange of voice data. As shown in FIG. 10, the computer terminal 450 sends the ACK message for the first voice data after the Health request message has been sent to the first TETRA radio 100. The first TETRA radio 100 acknowledges the receipt of the Health request message while the first computer terminal 450 acknowledges the receipt of the first voice data. The two ACK messages are handled asynchronously.

FIG. 11 illustrates a situation in which the second TETRA radio 200 receives a voice data from the first TETRA radio 100, and a Health request message is sent by the second TETRA radio 200 during the exchange of voice data. As shown in FIG. 11, the computer terminal 452 sends the ACK message for the first voice data after the Health request message has been sent by the second TETRA radio 200. The second computer terminal 450 acknowledges the receipt of the Health request message while the second TETRA radio 200 acknowledges the receipt of the first voice data. The two ACK messages are handled asynchronously. As shown in FIG. 11, a delay (for example, 15 ms) is introduced to allow the second TETRA radio 200 to process the confirmation message before the second computer terminal 452 continues to send voice data to the second TETRA radio 200.

It is noted that voice data must not be delayed or sent to a TETRA radio in a wrong order. For example, once a voice message has been sent by the first TETRA radio 100 and received by the second TETRA radio 200, subsequent voice data must be received by the second TETRA radio 200 within a predetermined time interval, e.g. an average rate of 30 ms with a maximum delay between the two messages of about 120 ms.

In an embodiment of the invention, compression of the voice data can be applied at the computer terminals to maintain the required rate (for example 30 ms), to ensure that the voice data are being transferred in a predetermined time interval in a low bandwidth bearer.

In an embodiment of the invention, a buffer is provided at each of the computer terminals 450, 452 to ensure that the voice data are transferred from the computer terminal to the TETRA terminal in a timely manner. Essentially, the computer terminal provides a buffer to buffer incoming data and sends them at a steady rate to the receiving TETRA radio. The size of the buffer can be determined based on latency and bandwidth of the network.

It is further noted that the buffer must not be underrun. If a buffer underrun is detected, the computer terminal will send a “PTT OFF” message to the receiving TETRA radio to stop receiving voice data for a predetermined time interval. Essentially, this allows the computer terminal to refill its buffer before sending further data to the TETRA radio.

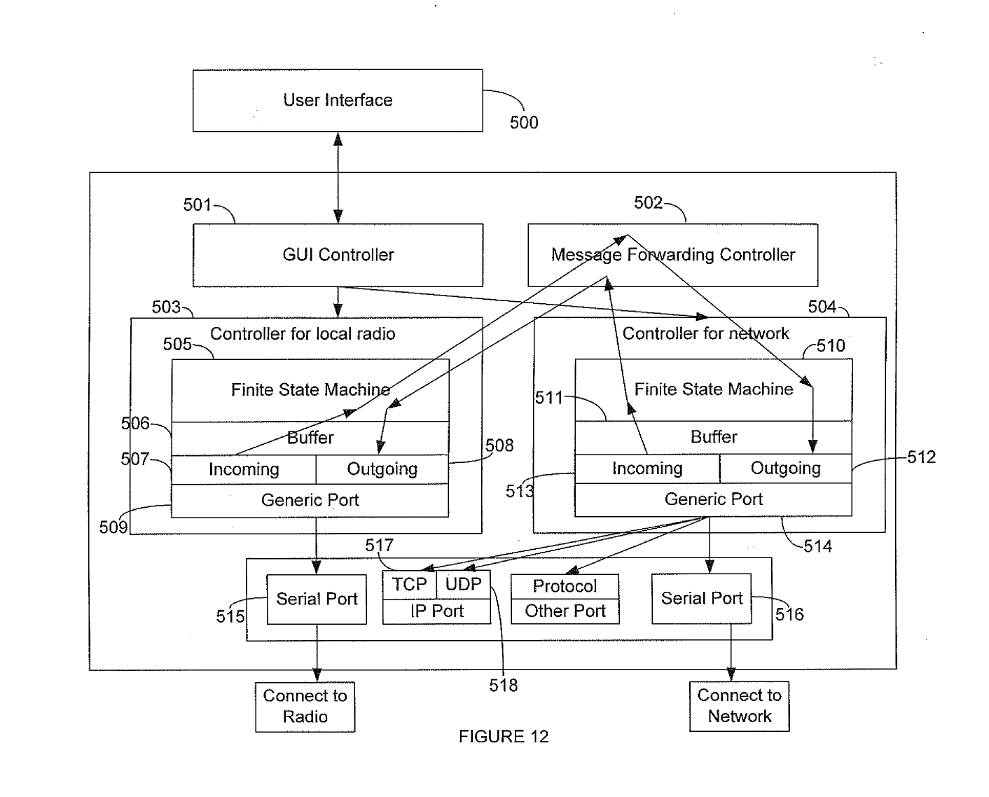

FIG. 12 shows a block diagram illustrating the key components of a computer terminal according to an embodiment of the invention.

A user interface 500 is connected to a GUI (Graphical User Interface) controller 501 to allow a user to control a call setup. The user interface includes user operable input devices such as, for example, a keyboard and a touchpad, but could include a mouse or other pointing device, a contact sensitive surface on a display unit of the computer terminal, a writing tablet, speech recognition means, haptic input means, or any other means by which a user input action can be interpreted and converted into data signals.

The GUI controller 501 is connected to two main controllers, namely a controller for a local radio 503 and a controller for a public network 504. The main controllers essentially control the flow of messages between the network and the local radio. Each of the main controllers includes a Finite State Machine 505, 510, a buffer 506, 511 which stores incoming and outgoing messages in the incoming units 507, 513 and the outgoing units 508, 512, and generic ports 509, 514. The Finite State Machine is configured to keep track of the state of the TETRA radios such that the computer terminal can connect to either of the TETRA radios independently.

The Finite State Machine 505, 510 is connected to a message forwarding controller 502. The message forwarding controller 502 is configured to pass messages between the two main controllers 503, 504.

The port controller includes a serial port 515 which connects the computer terminal to a radio, and another serial port 516 to connect the computer terminal to a network. The network protocol may be serial, TCP/IP 517, UDP/IP 518, or any other suitable protocols. The port controller is configured to locate the start and/or end of AT and DTSI messages. The port controller also parses the AT messages to decide whether the baud rate is required to changed.

The present invention can be implemented in dedicated hardware, using a programmable digital controller suitably programmed, or using a combination of hardware and software. The hardware may comprise personal radios, vehicle radios, or some other type of radio apparatus.

Alternatively, the present invention can be implemented by software or programmable computing apparatus. This includes any computer, including PDAs (personal digital assistants), mobile phones, etc. The code for each process in the methods according to the invention may be modular, or may be arranged in an alternative way to perform the same function. The methods and apparatus according to the invention are applicable to any computer with a network connection.

Thus the present invention encompasses a carrier medium carrying machine readable instructions or computer code for controlling a programmable controller, computer or number of computers as the apparatus of the invention. The carrier medium can comprise any storage medium such as a floppy disk, CD ROM, DVD ROM, hard disk, magnetic tape, or programmable memory device, or a transient medium such as an electrical, optical, microwave, RF, electromagnetic, magnetic or acoustical signal. An example of such a signal is an encoded signal carrying a computer code over a communications network, e.g. a TCP/IP signal carrying computer code over an IP network such as the Internet, an intranet, or a local area network.

Although the above described embodiments relate to the Thales Vector Secure Communication System, it is equally possible to implement the present invention using alternative hardware, in order to allow two TETRA radios or TETRA u-plane bearers to operate together as a TETRA gateway or repeater for unmodified standard TETRA-compliant terminals.

While the invention has been described in terms of what are at present its preferred embodiments, it will be apparent to those skilled in the art that various changes can be made to the preferred embodiments without departing from the scope of the invention, which is defined by the claims.

1. A TETRA communications system, comprising:
a first TETRA communication device, operable to establish a first communications link in an ETSI standard TETRA direct mode or trunked mode with a respective other device or devices;
a first communication means connected to said first TETRA communication device by means of a first data link to transport TETRA message data and control information between said first communication means and said first TETRA communication device;
a second TETRA communication device, operable to establish a second communications link in an ETSI standard TETRA direct mode or trunked mode with a respective other device or devices;
a second communication means connected to said second TETRA communication device by means of a second data link to transport TETRA message data and control information between said second communication means and said second TETRA communication device;
wherein said first communication means and said second communication means are further operable to establish a communications link with each other over a communications network to allow said message data and control information to be transported between said first TETRA communication device and said second TETRA communication device via said first communication means and said second communication means; and
further comprising a control means connected to said first TETRA communications device or said second TETRA communication device to control operation of said first and second TETRA communications devices.

2. The TETRA communications system according to claim 1, wherein each of said first and second communication means is operable to transmit an acknowledgment signal to its respective first and second TETRA communication devices within a predetermined time interval, upon reception of a message data from said respective first and second TETRA communication devices.

3. The TETRA communications system according to claim 1, wherein said first communication means is operable to transmit an acknowledgement signal to said second communication means upon reception of a message data from said second communication means.

4. The TETRA communications system according to claim 1, wherein said second communication means is operable to transmit an acknowledgement signal to said first communication means upon reception of a message data from said first communication means.

5. The TETRA communications system according to claim 1, wherein each of said first and second communication means includes a data storage means for storing an interim response to said message data.

6. The TETRA communications system according to claim 5, wherein each of said first and second communication means is operable to transmit said interim response to its respective first and second TETRA communication devices upon reception of said message data.

7. The TETRA communications system according to claim 5, wherein each of said first communication means is operable to update said data storage means with a response upon reception of said response from said second communication means.

8. The TETRA communications system according to claim 5, wherein each of said second communication means is operable to update said data storage means with a response upon reception of said response from said first communication means.

9. The TETRA communications system according to claim 1, wherein each of said first and second communication means is operable to monitor traffic on its respective first and second data link.

10. The TETRA communications system according to claim 1, wherein each of said first and second communication means is operable to compress said message data.

11. The TETRA communications system according to claim 5, wherein each of said first and second communications means is operable to configure said data storage means to operate as a data buffer for storing a received message data.

12. The TETRA communications system according to claim 5, wherein each of said first and second communication means is operable to control the rate at which said received message data is transmitted to its respective first and second TETRA communication devices upon reception of said message data.

13. The TETRA communications system according to claim 1, wherein each of said first and second data link comprises a local low delay wired or wireless link.

14. The TETRA communications system according to claim 13, wherein said each of said first and second data link is a serial data cable.

15. The TETRA communications system according to claim 1, wherein said communications network comprises a packet network or a switched network.

16. A TETRA communications apparatus, comprising:
a TETRA communication device, operable to establish a communications link in an ETSI standard TETRA direct mode or trunked mode with a respective other device or devices;
a communication means connected to said TETRA communication device by means of a data link to transport TETRA message data and control information between said communication means and said TETRA communication device;
wherein said communication means is operable to establish a communications link with another communication means over a communications network to allow said message data and control information to be transported to another communication means connected to said communications network,
further comprising a control means connected to said TETRA communications device to control operation of said TETRA communications device.

17. The TETRA communications apparatus according to claim 16, wherein said communication means is operable to transmit an acknowledgment signal to said TETRA communication device within a predetermined time interval, upon reception of a message data from said TETRA communication device.

18. The TETRA communications apparatus according to claim 17, wherein said first communication means includes a data storage means for storing an interim response to said message data from said first TETRA communication device.

19. The TETRA communications apparatus according to claim 18, wherein said communication means is operable to transmit said interim response to said communication device upon reception of said message data from said second TETRA communication device.

20. The TETRA communications apparatus according to claim 18, wherein said communication means is operable to update said data storage means with a response upon reception of said response from said another communication means.

21. The TETRA communications apparatus according to claim 16, wherein said communication means is operable to monitor traffic on said data link.

22. The TETRA communications apparatus according to claim 16, wherein said communication means is operable to compress said message data.

23. The TETRA communications apparatus according to claim 19, wherein said communications means is operable to configure said data storage means to operate as a data buffer for storing a received message data.

24. The TETRA communications apparatus according to claim 17, wherein said communication means is operable to control the rate at which said received message data is transmitted to said TETRA communication device.

25. The TETRA communications apparatus according to claim 17, wherein said data link comprises a local low delay wired or wireless link.

26. TETRA communications apparatus according to claim 25 wherein said data link is a serial data cable.

27. The TETRA communications apparatus according to claim 17, wherein said communications network comprises a packet or a switched network.

28. A method of controlling a TETRA communications system, the method comprising:
using a first TETRA communication device to establish a first communications link in an ETSI standard TETRA direct mode or trunked mode with a respective other device or devices;
using a first data link to transport TETRA message data and control information between a first communication means and said first TETRA communication device;
using a second TETRA communication device, operable to establish a second communications link in an ETSI standard TETRA direct mode or trunked mode with a respective other device or devices;
using a second data link to transport TETRA message data and control information between a second communication means and said second TETRA communication device; and
operating said first communication means and said second communication means to establish a communications link with each other over a communications network to allow said message data and control information to be transported between said first TETRA communication device and said second TETRA communication device via said first communication means and said second communication means.

29. The method according to claim 28, comprising transmitting an acknowledgment signal from each of said first and second communication means to its respective first and second communications devices within a predetermined time interval, upon reception of a message data from said respective first and second communications devices.

30. The method according to claim 28, comprising transmitting an acknowledgement signal from said first communication means to said second communication means upon reception of a message data from said second communication means.

31. The method according to claim 28, comprising transmitting an acknowledgement signal from said second communication means to said first communication means upon reception of a message data from said first communication means.

32. The method according to claim 28, comprising storing an interim response to said message data in a storage means of each of said first and second communication means.

33. The method according to claim 32, comprising transmitting said interim response from each of said first and second communication means to its respective first and second communication devices upon reception of said message data.

34. The method according to claim 32, further comprising updating said storage means of said first communication means with a response upon reception of said response from said second communication means.

35. The method according to claim 32, further comprising updating said storage means of said second communication means with a response upon reception of said response from said first communication means.

36. The method according to claim 28, comprising monitoring traffic on said first and second data link.

37. The method according to claim 28, comprising compressing said message data.

38. The method according to claim 28, comprising configuring said data storage means as a data buffer for storing a received message data.

39. The method according to claim 28, comprising controlling the rate at which said message data is transmitted from each of said first and second communication means to its respective first and second communication devices upon reception of said received message data.

40. A method at a TETRA communications apparatus, the method comprising:
using a TETRA communication device to establish a communications link in an ETSI standard TETRA direct mode or trunked mode with a respective other device or devices;
using a data link to connect a communication means to said TETRA communication device to transport TETRA message data and control information between said communication means and said TETRA communication device;
establishing a communications link between said communication means and another communication means over a communications network to allow said message data and control information to be transported to another communication means connected to said communications network; and
controlling operation of said TETRA communications device.

41. The method according to claim 40, comprising transmitting an acknowledgment signal from said communication means to said TETRA communication device within a predetermined time interval, upon reception of a message data from said TETRA communication device.

42. The method according to claim 40, comprising storing an interim response to said message data in a data storage means in said communication means.

43. The method according to claim 42, comprising transmitting said interim response from said communication means to said TETRA communication device upon reception of said message data received from said TETRA communication device.

44. The method according to claim 42, comprising updating said data storage means with a response upon reception of said response from said another communication means.

45. The method according to claim 40, comprising monitoring traffic on said data link.

46. The method according to claim 40, comprising compressing said message data.

47. The method according to claim 43, comprising configuring said data storage means as a data buffer for storing a received message data.

48. The method according to claims 41, comprising controlling the rate at which said message data is transmitted from said communication means to said TETRA communication device upon reception of said received message data.
